(19) United States
(12) Patent Application Publication
(10) Pub. No.: US 2023/0265002 A1
(43) Pub. Date: Aug. 24, 2023

(54) Dual Drying Path With Exhaust Recirculation for Solid Waste Processing

(71) Applicant: Biowaste Pyrolysis Solutions, LLC, Lantana, FL (US)

(72) Inventors: Samuel Sylvetsky, Schenectady, NY (US); Richard Bingham, Johannesburg (ZA); Jeannette Brown, Darien, CT (US)

(21) Appl. No.: 18/010,250

(22) PCT Filed: Jul. 2, 2021
(86) PCT No.: PCT/US21/40301

§ 371 Date: Dec. 14, 2022

Related U.S. Application Data
(60) Provisional application No. 63/049,342, filed on Jul. 8, 2020.

(51) Int. Cl. C02F 11/10; C02F 11/127

(52) U.S. Cl. CPC C02F 11/10; C02F 11/127; C02F 2103/005

(57) ABSTRACT

A technique, method and system for drying a solid waste stream in a pyrolysis recycling installation, including drying the waste stream in a first dryer, feeding the partially dried waste stream from the first dryer to a second dryer, further drying the waste stream in the second dryer to produce a dried waste stream, and feeding the dried waste stream from the second dryer to a pyrolysis unit, wherein the first and second dryers dry the waste stream primarily, or exclusively, using heat generated from the pyrolysis unit.

### CROSS-REFERENCE TO RELATED APPLICATION

The present invention claims priority benefit of U.S. Provisional Patent Application No. 63/049,342 filed Jul. 8, 2020, entitled “Dual Drying Path With Exhaust Recirculation for Solid Waste Processing,” which is hereby incorporated by reference.

### BACKGROUND

Disposing of sewer waste is a global problem. The potential reach and impact of a pyrolysis solution for such waste is nearly unlimited.

### BRIEF SUMMARY OF THE INVENTION

With parenthetical reference to the corresponding parts, portions or surfaces of the disclosed embodiment, merely for the purposes of illustration and not by way of limitation, the present invention provides a technique, method and system for drying a solid waste stream (20) in a pyrolysis recycling installation (10), including drying the waste stream (20) in a first dryer (32), feeding the waste stream (20) from the first dryer (32) to a second dryer (34), further drying the waste stream (20) in the second dryer (32), and feeding the dried waste stream (22) from the second dryer (34) to a pyrolysis unit (40), wherein the first and second dryers (32, 34) dry the waste stream (20) primarily, or exclusively, using heat generated from the pyrolysis unit (40).

The first dryer (32) may be a belt-type dryer and the waste stream (20) is dried while being supported by a plurality of moving belts therein. The first dryer (32) may be a low energy high evaporation (“LEHE”) dryer accepting the waste stream (20) with about 15 to 25% solids, and drying the waste stream (20) to about 55 to 75% solids.

The second dryer (34) may be a rotary drum-type dryer wherein the waste stream (20) is dried while being moved inside a rotating drum, guided therethrough by angular blades in the rotating drum. The second dryer (34) may be a direct thermal dryer accepting said waste stream (20) from the first dryer (32), and drying the waste stream (20) to about 90% solids to produce a dried waste stream (22).

A portion of the dried waste stream (22) from the second dryer (34) may be mixed with the waste stream (20) output from the first dryer (32) to further dry said waste stream (20).

In one aspect, the present invention provides a method of drying a solid waste stream (20) in a pyrolysis recycling installation (10). The method includes drying the waste stream (20) in a first dryer (32) to produce a partially dried waste stream. The partially dried waste stream (20) is fed from the first dryer (32) to a second dryer (34). The method further comprises drying the waste stream (20) in the second dryer (34) to produce a dried waste stream. The dried waste stream (22) is fed from the second dryer (34) to a pyrolysis unit (40). The first and second dryers (32, 34) dry the waste stream (20) primarily, or exclusively, using heat generated from the pyrolysis unit (40).

In another aspect of the invention, the first dryer (32) is a belt-type dryer and the waste stream (20) is dried while being supported by a plurality of moving belts therein.

In yet another aspect, the second dryer (34) is a rotary drum-type dryer wherein the waste stream (20) is dried while being moved inside a rotating drum, guided therethrough by angular blades in the rotating drum.

In another aspect of the invention the first dryer (32) is a low energy high evaporation dryer accepting the waste stream (20) with about 15 to 25% solids, and drying the waste stream (20) to produce a partially dried waste stream containing about 55 to 75% solids.

In another aspect, the second dryer (34) is a direct thermal dryer accepting said waste stream (20) from the first dryer (32), and drying the partially dried waste stream (20) to produce a dried waste stream (22) containing about 90% solids.

In yet another aspect, a portion of the dried waste stream (22) from the second dryer (34) is mixed with the partially dried waste stream (20) output from the first dryer (32) to further dry said waste stream (20) prior to entering the second dryer (34).

In another aspect, the present invention provides a system for drying a solid waste stream (20) in a pyrolysis recycling installation (10). The system includes a first dryer (32) drying the waste stream (20). A second dryer (34) further dries the waste stream (20) that is received from the first dryer (32). The dried waste stream (22) is then fed to a pyrolysis unit (40) processing the waste stream (22) and generating heat. The first and second dryers (32, 34) dry the waste stream (20) primarily, or exclusively, using heat generated from the pyrolysis unit (40).

In another aspect, the first dryer (32) is a belt-type dryer and the waste stream (20) is dried while supported by a plurality of moving belts therein.

In another aspect of the invention, the second dryer (34) is a rotary drum-type dryer wherein the waste stream (20) is dried while being moved inside a rotating drum, guided therethrough by angular plates in the rotating drum.

In yet another aspect, the first dryer (32) is a low energy high evaporation-type dryer accepting the waste stream (20) with about 15 to 25% solids, and drying the waste stream (20) to produce a partially dried waste stream containing about 55 to 75% solids.

In another aspect, the second dryer (34) is a direct thermal dryer accepting said partially dried waste stream (20) from the first dryer (32), and drying the waste stream (20) to produce a dried waste stream (22) containing about 90% solids.

In one aspect of the invention, a portion of the dried waste stream (22) from the second dryer (34) is mixed with the waste stream (20) output from the first dryer (32) to further dry said waste stream (20) prior to entering the second dryer (34).

### BRIEF DESCRIPTION OF THE DRAWINGS

FIG. 1 is a block diagram of a pyrolysis recycling installation, in accordance with aspects of the present invention; and

FIG. 2 is a schematic of an exemplary drying subsystem of a pyrolysis installation, in accordance with aspects of the present invention.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

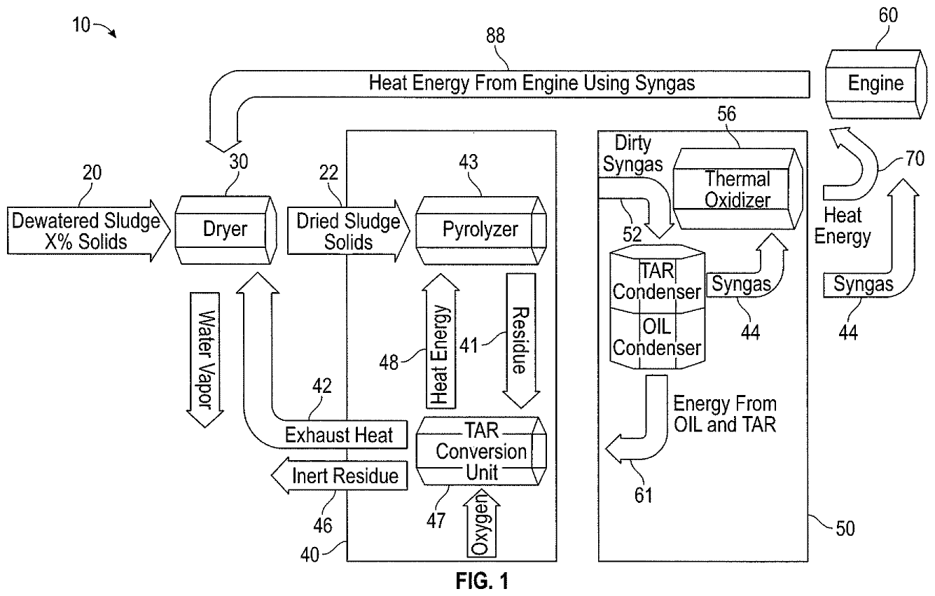

In one embodiment of the present invention, and initially with reference to FIG. 1, a pyrolysis recycling installation 10 receiving a waste stream 20 comprised of dewatered sludge may include four distinct subsystems: drying 30, pyrolysis unit 40, syngas cleaning 50 and system control (not shown). Each subsystem may be evaluated and custom designed to meet customer needs. At the same time, certain subsystems may be tied together to optimize re-circulated energy use. If the resulting energy is adequate, there may be an opportunity to generate hot water and/or electricity for other purposes using an engine 60.

In one example, a pyrolysis installation 10 may receive up to five tons per hour of a waste stream 20 with X % of biosolids where X may equal 15 to 25. The waste stream 20 may be received from nearby wastewater treatment plants.

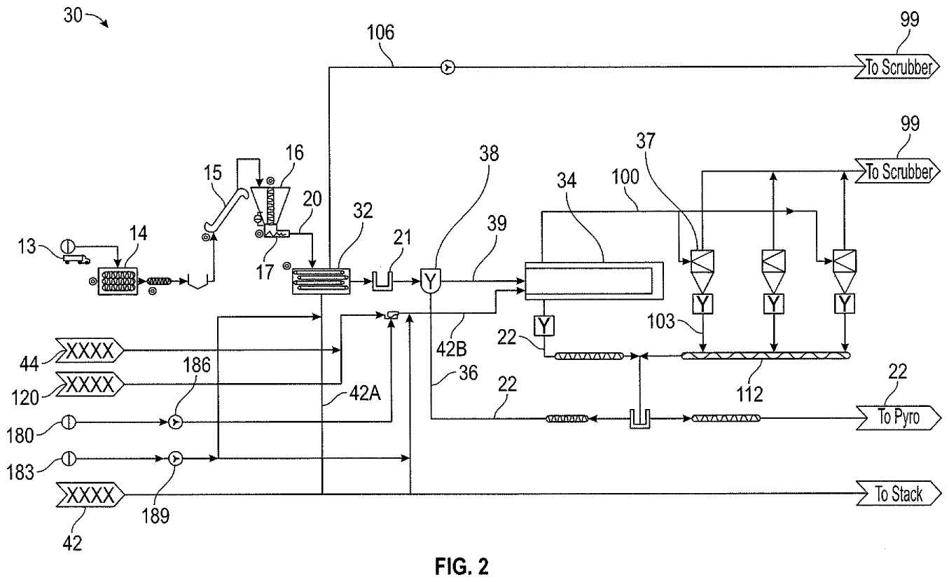

The waste stream 20 enters the drying subsystem 30 at about 15-20% solids and exits as a dried waste stream 22 with approximately 90% solids. The dried waste stream 22 exits the drying subsystem 30 and is fed into the pyrolysis unit 40. The pyrolyzer 43 produces carbonaceous residue 41 from the waste stream 22. The carbonaceous residue 41 may be fed to a tar conversion unit 47. The tar conversion unit 47 may produce exhaust heat 42 that can be used to heat the dryers 32, 34 (FIG. 2). The tar conversion unit 47 also produces inert residue 46. The tar conversion unit 47 may also return heat energy 48 to the pyrolyzer 43.

The pyrolysis unit 40 also produces syngas 52 that can be processed in the syngas cleaning subsystem 50 to produce heat energy 70 that can be returned to the drying system 30. Clean syngas 44 may be flared by the thermal oxidizer 56 or used to power an engine 60. In addition, energy 61 from the oil and tar separated from the syngas 52 may be used to provide energy for the tar conversion unit 47.

Turning to FIG. 2, the input waste stream 20 may be transported to the drying subsystem 30 by a truck 13 or other mode of transportation. The waste stream 20 may be temporarily stored in an external receiving bin 14. The waste stream 20 may be conveyed through a conduit 15 into a hopper 16. From the hopper 16, the waste stream 20 may pass through an extruder 17 into the first dryer 32. The partially dried waste stream 20 exiting first dryer 32 may be temporarily stored in a vessel 21. From vessel 21, the partially dried waste stream 20 may be conveyed to a dry product recycle mixer 38 where the partially dried stream 20 may be mixed with a portion of the fully dried stream 22 that has been diverted from the output of the second dryer 34. From the mixer 38, the partially dried waste stream 20 (mixed with a portion of the dried waste stream 22) may be conveyed through conduit 39 to second dryer 34.

The waste stream 20 may be first dried using a low energy/heat high evaporation (“LEHE”) dryer 32 followed by a rotary dryer 34, in series. Those skilled in the art will recognize that the stream feeding paths in the present invention may be direct or indirect, e.g., may contain intervening storage areas/flow control. At least one, or both, dryers 32, 34 use primarily, or exclusively, exhaust heat 42 from the pyrolysis unit 40 as their primary source of heat for drying. Syngas-generated heat 70 can also be used if exhaust heat 42 is not sufficient. The dried waste stream 22 can be fed into the pyrolysis unit 40 where it is heated to produce syngas 52. The pyrolysis unit 40 also produces carbonaceous residue 41. In one embodiment, the excess syngas 44 will be flared, but syngas 44 may also be used in engine 60 to produce heat energy 88 and/or electricity to use in the plant or feed externally. The carbonaceous residue 41 can be used to produce heat energy 48 to heat the pyrolysis unit 40.

In one embodiment of the invention, wastewater 20 containing solids is dried using a LEHE dryer 32 and rotary dryer 34 in series. LEHE dryer 32 may accept the waste stream 20 with about 15 to 25% solids and dries it to produce a partially dried waste stream 20 containing about 60-70% solids. The partially dried waste stream 20 can then be transferred/fed to the rotary thermal dryer 34 which dries the stream to produce a dried waste stream 22 containing about 90% solids. The dryers 32, 34 operate using primarily heat and/or heated gases 42 (42a and 42b in FIG. 2) recirculated from the pyrolysis unit 40.

### Dryer 32—Low Energy High Evaporation (“LEHE”)

Dryer 32 in one embodiment may be a belt dryer—including multiple belts (for example stainless steel) top to bottom—with a drying time over an extended period, in one example two to four hours. The belts move in alternate directions and the waste is dropped between belts. The dryer 32 takes out about two-thirds of the water. The actual solids content post belt dryer 32 is close to 60-70% in one example. More generally the range can be 55-75% solids. In one example, the temperature maintained in dryer 32 is sub-boiling, may be about 150-212 degrees Fahrenheit.

### Dryer 34—Rotary Dryer

Dryer 34 in one embodiment may be a two pass rotary dryer—e.g., a “direct drum dryer” approach (as opposed to indirect). Faster drying time is achieved in this regard, more heat is applied directly into drum, where the waste stream 20 travels less. The entire drum rotates as heat is fed directly in the drum. The waste stream 20 travels along an inner portion first, and then back in an outer portion, guided by lifting plates (mounted perpendicular to the inside of the drum) and progress plates (mounted angularly to the inside of the drum). The progress plates are oppositely disposed—and push the waste stream 20 in different directions. In one example, the temperature maintained in dryer 34 is over-boiling, about 212-250 degrees Fahrenheit.

The advantages of the two drying phases include but are not limited to the following. The LEHE drum 32 may be very efficient—and handles the waste through its “sticky phase”— where it is a partially dewatered, paste-like material that can adhere to the surface of the drying equipment. It is dried to e.g., approximately 60-70% solids, or more generally about 55-75%. The belt dryer 32 more easily handles product through the sticky phase, because there is no turbulence across surfaces, rather the waste is supported by moving belts. In one embodiment, some output material 22 can be “mixed”—using dry product remixer 38 which accepts a return stream of dry product 22 through conduit 36 from the rotary dryer 34 and/or cyclone arrangement 37, and dries up to 75% in one embodiment.

Preferably for pyrolysis, the second dryer 34 achieves 90% solids and, the thermal, “direct” rotary dryer 34 uses exhaust heat 42b (FIG. 2) only—no extra syngas may be needed.

In this approach, no re-mixing may be needed with dry material (though in one embodiment a return stream 36/38 can be used); and all of the heat 42 used for drying by one or both dryers 32, 34 is recirculated from the pyrolysis unit 40. This results in a thermally, energy, and material-efficient system operating in closed loop fashion with its only input comprising the waste stream 20, and the outputs comprising exhaust gas (which can be scrubbed) and syngas 44 which can be either flared or used for beneficial purposes (e.g., generating electricity for the plant or outside the plant).

The exhaust gases from the dryers 32, 34 can then be combined before being treated by a packed bed wet scrubber 99. All of the air emissions associated with the dryers 32, 34 and pyrolysis unit 40 pass through the scrubber 99 and exit the process stack.

The humid exhaust gas 100 can be passed through cyclones 37 to recover suspended particulate material 103 from the rotary dryer 34. The particulate material 103 may be fed through line 112 and combined with the dried waste stream 22. Exhaust 100 from the rotary dryer 34 can combine with the exhaust 106 from the low heat dryer 32 and be treated in a packed bed wet scrubber 99 to condense water vapor, capture particulate matter and absorb gaseous contaminants.

Syngas 52 produced in the pyrolysis unit 40 can be conditioned to condense semi-volatile compounds and tars. The resulting Syngas 44 consists of carbon monoxide (CO), hydrogen (H2), methane (CH4) and carbon dioxide (CO2). In one embodiment, this gas 44 will be sent to a flare in the process exhaust stack. Once the quantity of Syngas 44 available for use is defined, it can used to size an appropriate engine 60 and generate electricity. The exhaust from the flare will combine with the exhaust from the scrubber 99 and discharge through the process stack.

In one example, the plant can generate 750 kW electricity, in one example 350 kW electricity recycled, balance (400 kW) can be flared.

In accordance with the present invention the dried solids 22 can be used to generate heat that is returned to the drying process and a syngas 44 that is used to generate energy. The use of natural gas 120 is limited to cold startups.

Combustion air 180 and dilution air 183 may be produced by fans 186, 189 disposed in the system as will be evident to those of ordinary skill in the art based on this disclosure.

Aside from a small amount of fuel required for startup, the proposed installation 10 can produce all its own energy. There will be no fuel bills for heating or drying. Once at a steady state the system can run for months, with little to no maintenance.

Syngas or synthetic gas is the byproduct of pyrolysis. By heating a carbon based material under special conditions, the material breaks down into smaller components (thermal decomposition). Natural gas by comparison is 95% methane (CH4). Syngas composition will vary. However, the typical composition is carbon monoxide, hydrogen and methane (CH4). While syngas is not as concentrated in energy as natural gas, it has plenty of BTUs.

The system can be closed and self-contained. Minor day to day house cleaning can be performed by local staff. An electronic control panel may be installed and monitored.

The foregoing and other objects, features, and advantages of the invention are apparent from the detailed description taken in combination with the accompanying drawings.

The subject matter regarded as the invention is particularly pointed out and distinctly claimed at the conclusion of the specification. The present invention contemplates that many changes and modifications may be made. Therefore, while the presently-preferred form of the dual drying path with exhaust recirculation for solid waste processing has been shown and described, and several modifications and alternatives discussed, persons skilled in this art will readily appreciate that various additional changes and modifications may be made without departing from the spirit of the invention, as defined and differentiated by the following claims.

1. A method of drying a waste stream in a pyrolysis recycling installation, comprising:
drying the waste stream in a first dryer to produce a partially dried waste stream,
feeding the partially dried waste stream from the first dryer to a second dryer,
further drying the partially dried waste stream in the second dryer to produce a dried waste stream, and
feeding the dried waste stream from the second dryer to a pyrolysis unit,
wherein the first and second dryers primarily, or exclusively, use heat generated from the pyrolysis unit for drying.

2. The method of claim 1, wherein the first dryer is a belt-type dryer and the waste stream is dried while being supported by a plurality of moving belts therein.

3. The method of claim 1, wherein the second dryer is a rotary drum-type dryer wherein the partially dried waste stream is further dried while being moved inside a rotating drum.

4. The method of claim 3, wherein the partially dried waste stream is guided through the second dryer by angular blades in the rotating drum.

5. The method of claim 1, wherein the first dryer is a low energy high evaporation dryer accepting the waste stream with about 15 to 25% solids, and drying the waste stream to produce the partially dried waste stream containing about 55 to 75% solids.

6. The method of claim 1, wherein the second dryer is a direct thermal dryer accepting said partially dried waste stream from the first dryer, and drying the waste stream to produce the dried waste stream containing about 90% solids.

7. The method of claim 1, wherein a portion of the dried waste stream from the second dryer is mixed with the partially dried waste stream from the first dryer to further dry said partially dried waste stream prior to the partially dried waste stream being fed to the second dryer.

8. The method of claim 1, wherein the pyrolysis unit further comprises a pyrolyzer and a tar conversion unit.

9. The method of claim 8, wherein the tar conversion unit generates heat energy for use by the pyrolyzer.

10. The method of claim 1 wherein the pyrolysis unit produces synthetic gas from processing the dried waste stream.

11. The method of claim 10, wherein the synthetic gas is flared in a thermal oxidizer.

12. The method of claim 10, wherein the synthetic gas provides heat energy to the second dryer.

13. A system for drying a solid waste stream in a pyrolysis recycling installation, comprising:
a first dryer drying the waste stream,
a second dryer further drying the waste stream received from the first dryer, and feeding the waste stream to a pyrolysis unit processing the waste stream and generating heat,
wherein the first and second dryers dry the waste stream primarily, or exclusively, using heat generated from the pyrolysis unit.

14. The system of claim 13, wherein the first dryer is a belt-type dryer and the waste stream is dried while supported by a plurality of moving belts therein.

15. The system of claim 13, wherein the second dryer is a rotary drum-type dryer wherein the waste stream is dried while being moved inside a rotating drum.

16. The system of claim 15, wherein the waste stream is guided through the second dryer by angular plates in the rotating drum.

17. The system of claim 13, wherein the first dryer is a low energy high evaporation-type dryer accepting the waste stream with about 15 to 25% solids, and drying the waste stream to about 55 to 75% solids.

18. The system of claim 13, wherein the second dryer is a direct thermal dryer accepting said waste stream from the first dryer, and drying the waste stream to about 90% solids.

19. The system of claim 13, wherein a portion of the dried waste stream from the second dryer is mixed with the waste stream output from the first dryer to further dry said waste stream.

20. The system of claim 13, wherein the pyrolysis unit further comprises a pyrolyzer and a tar conversion unit.

21. The system of claim 20, wherein the tar conversion unit generates heat energy for use by the pyrolyzer.

22. The system of claim 1 wherein the pyrolysis unit produces synthetic gas.

23. The system of claim 22, wherein the synthetic gas is flared in a thermal oxidizer.

24. The system of claim 22, wherein the synthetic gas provides heat energy to the second dryer.
